(19) United States
(12) Patent Application Publication
(10) Pub. No.: US 2026/0077797 A1
(43) Pub. Date: Mar. 19, 2026

(54) STROLLER ATTACHMENT MECHANISM

(71) Applicant: MONAHAN PRODUCTS, LLC, Rockland, MA (US)

(72) Inventors: Carl J. Sukeforth, Milton, MA (US); Luis Alejandro Canas, Stoughton, MA (US)

(21) Appl. No.: 19/330,039

(22) Filed: Sep. 16, 2025

Related U.S. Application Data
(60) Provisional application No. 63/695,519, filed on Sep. 17, 2024.

(51) Int. Cl. B62B 7/14; B62B 7/00; B62B 7/06

(52) U.S. Cl. CPC B62B 7/142; B62B 7/008; B62B 7/064

(57) ABSTRACT

A stroller includes a frame, a seat configured to be releasably secured to the frame, an attachment mount associated with the frame, and a mating attachment mount associated with the seat. The mating attachment mount has a shape configured to conform to a shape of the attachment mount. The stroller further includes a locking assembly configured to releasably secure the mating attachment mount to the attachment mount.

### CROSS-REFERENCE TO RELATED APPLICATION

This application claims the benefit under 35 U.S. C. § 119(e) of co-pending U.S. Provisional Ser. No. 63/695,519 titled STROLLER ATTACHMENT MECHANISM filed on Sep. 17, 2024, which is incorporated herein by reference in its entirety for all purposes.

### BACKGROUND

The present disclosure is directed to child conveyance devices, for example, strollers, and more particularly to an attachment mechanism configured to releasably secure a seat to a frame of the stroller.

A stroller is generally a chair-like carriage with wheels for transporting a baby or child. Some strollers may include a single seat for receiving a single passenger for transport, while other types of strollers include two or more seats. Strollers may include a set of four wheels or may be in a tricycle configuration including three wheels. A certain type of stroller is designed to receive and secure one or more car seat to a frame of the stroller, for example a seat that also can be used as a car seat.

### SUMMARY

One aspect of the present disclosure is directed to a stroller comprising a frame, a seat configured to be releasably secured to the frame, an attachment mount associated with the frame, and a mating attachment mount associated with the seat. The mating attachment mount has a shape configured to conform to a shape of the attachment mount. The stroller further comprises a locking assembly configured to releasably secure the mating attachment mount to the attachment mount.

Embodiments of the stroller further may include configuring the attachment mount with a hollow body configured to fit over a crossbar of the frame. The attachment mount further may include at least one attachment feature formed on the hollow body on the top of the hollow body. The at least one attachment feature may be configured to prevent relative rotation of the mating attachment mount with respect to the attachment mount. The hollow body may include a V-shaped outer surface. The mating attachment mount may include an inverted V-shaped body configured to fit over the V-shaped outer surface of the hollow body of the attachment mount. The locking assembly may include at least one latch configured to engage a recess formed in the hollow body of the attachment mount. The at least one latch may include a wedge-shaped element that is sized and shaped to fit within the recess of the hollow body of the attachment mount. The locking assembly further may include a release slide that is configured to secure the mating attachment mount to the attachment mount. The release slide may be positioned within a slot formed in a top surface of the inverted V-shaped body of the mating attachment mount. The release slide may be configured to be biased by a spring to move the wedge-shaped element of the at least one latch within the recesses of the attachment mount and the mating attachment mount to secure the mating attachment mount to the attachment mount. The at least one latch may include a bottom end portion that is captured within a retention feature formed in the side of the inverted V-shaped body. The at least one latch further may include a top end portion that is coupled to a latch drive link. The latch drive link may be coupled to the release slide so that when the release slide is moved laterally against the bias of the spring. The latch drive link may be moved outboard with respect to the inverted V-shaped body to rotate the latch so that the wedge-shaped element of the latch is removed from its respective recess. The mating attachment mount may include a release slide that is configured to releasably secure the mating attachment mount to the at least one attachment feature of the attachment mount. The release slide may be positioned within a slot formed in a top surface of an inverted V-shaped body of the mating attachment mount. The release slide may include a first slide portion and a second slide portion that is configured to be biased away from the first slide portion. The second slide portion may be biased away from the first slide portion by a spring.

Another aspect of the present disclosure is directed to a method of releasably securing a seat to a frame of a stroller. In one embodiment, the method comprises: providing an attachment mount with the frame of the stroller; providing a mating attachment mount with the seat; positioning the mating attachment mount of the seat over the attachment mount of the frame of the stroller; lowering the mating attachment mount of the seat onto the attachment mount of the frame so that surfaces of the mating attachment mount guide the attachment mount over surfaces of the attachment mount; and releasably securing the mating attachment mount of the seat to the attachment mount of the frame of the stroller,

Embodiments of the method further may include configuring the mating attachment mount with a shape configured to conform to a shape of the attachment mount and providing a locking assembly configured to releasably secure the mating attachment mount to the attachment mount. The attachment mount further may include a hollow body configured to fit over a crossbar of the frame. The method further may comprise preventing relative rotation of the mating attachment mount with respect to the attachment mount with at least one attachment feature formed on the hollow body on the top of the hollow body. The hollow body may include a V-shaped outer surface and the mating attachment mount may include an inverted V-shaped body configured to fit over the V-shaped outer surface of the hollow body of the attachment mount. Releasably securing the mating attachment mount of the seat to the attachment mount may include moving a releasable slide of the mating attachment mount to engage the at least one attachment feature of the attachment mount.

Yet another aspect of the present disclosure is directed to an attachment mechanism for a stroller including a frame and a seat configured to be releasably secured to the frame. The attachment mechanism comprises an attachment mount associated with the frame, a mating attachment mount associated with the seat, the mating attachment mount having a shape configured to conform to a shape of the attachment mount, and a locking assembly configured to releasably secure the mating attachment mount to the attachment mount.

Embodiments of the attachment mechanism further may include configuring the attachment mount with a hollow body configured to fit over a crossbar of the frame. The attachment mount further may include at least one attachment feature formed on the hollow body on the top of the hollow body. The at least one attachment feature may be configured to prevent relative rotation of the mating attachment mount with respect to the attachment mount. The hollow body may include a V-shaped outer surface. The mating attachment mount may include an inverted V-shaped body configured to fit over the V-shaped outer surface of the hollow body of the attachment mount. The attachment mechanism of claim 26, wherein the locking assembly of the mating attachment mount includes at least one latch configured to engage a recess formed in the hollow body of the attachment mount. The at least one latch may include a wedge-shaped element that is sized and shaped to fit within the recess of the hollow body of the attachment mount. The locking assembly of the mating attachment mount further may include a release slide that is configured to secure the mating attachment mount to the attachment mount. The release slide may be positioned within a slot formed in a top surface of the inverted V-shaped body of the mating attachment mount. The release slide may be configured to be biased by a spring to move the wedge-shaped element of the at least one latch within the recess of the attachment mount to secure the mating attachment mount to the attachment mount. The at least one latch may include a bottom end portion that is captured within a retention feature formed in the side of the inverted V-shaped body. The at least one latch further may include a top end portion that is coupled to a latch drive link. The latch drive link may be coupled to the release slide so that when the release slide is moved laterally against the bias of the spring. The latch drive link may be moved outboard with respect to the inverted V-shaped body to rotate the latch so that the wedge-shaped element of the latch is removed from its respective recess. The mating attachment mount may include a release slide that is configured to releasably secure the mating attachment mount to the at least one attachment feature of the attachment mount. The release slide may be positioned within a slot formed in a top surface of an inverted V-shaped body of the mating attachment mount. The release slide may include a first slide portion and a second slide portion that is configured to be biased away from the first slide portion. The second slide portion may be biased away from the first slide portion by a spring.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a back perspective view of a stroller having an attachment mechanism of an embodiment of the disclosure;

FIG. 2 is an enlarged perspective view of a portion of the stroller having the attachment mechanism;

FIG. 3 is a front perspective view of the stroller showing a frame of the stroller having two attachment mounts;

FIG. 4 is an enlarged perspective view of one of the attachment mounts;

FIG. 5 is a perspective view of a seat frame having a mating attachment mount;

FIG. 6 is an enlarged cross-sectional perspective view of the attachment mount and the mating attachment mount in a secured position with respect to one another;

FIG. 7 is an enlarged perspective view of the mating attachment mount including a latch having a wedge-shaped feature;

FIG. 8 is an enlarged perspective view of the mating attachment mount including a release slide configured to secure the mating attachment mount to the attachment mount;

FIG. 9 is a cross-sectional view of the mating attachment mount shown in FIG. 8;

FIG. 10 is another cross-sectional view of the mating attachment mount shown in FIG. 8;

FIG. 11 is a perspective view of the latch having the wedge-shaped feature;

FIG. 12 is an enlarged cross-sectional side view of the mating attachment mount prior to being secured to the attachment mount;

FIG. 13 is an enlarged cross-sectional side view of the mating attachment mount being lowered onto the attachment mount;

FIG. 14 is an enlarged cross-sectional side view of the mating attachment mount secured to the attachment mount;

FIG. 15 is a force diagram of the attachment mechanism;

FIG. 16 is an enlarged perspective view of a mating attachment mount of another embodiment of the disclosure;

FIG. 17 is an enlarged perspective view of a mating attachment mount of another embodiment of the disclosure;

FIG. 18 is another enlarged perspective view of the mating attachment mount shown in FIG. 17;

FIG. 19 is an enlarged perspective view of a mating attachment mount of another embodiment of the present disclosure;

FIG. 20 is an enlarged perspective view of a mating attachment mount of another embodiment of the present disclosure;

FIG. 21 is an enlarged exploded perspective view of the mating attachment mount shown in FIG. 20;

FIG. 22 is an enlarged cross-sectional view of the mating attachment mount shown in FIG. 20;

FIG. 23 is another enlarged cross-sectional view of the mating attachment mount shown in FIG. 20;

FIG. 24 is an enlarged cross-sectional view of the mating attachment mount shown in FIG. 20 illustrating dimensions of the mating attachment mount;

FIG. 25 is an enlarged perspective of the mating attachment mount shown in FIGS. 5-15 illustrating a spring used to bias the release slide;

FIG. 26 is an enlarged exploded perspective view of the mating attachment mount shown in FIGS. 5-15; and

FIG. 27 is another enlarged exploded perspective view of the mating attachment mount shown in FIGS. 5-15.

### DETAILED DESCRIPTION

Parents or caregivers of young children or babies may transport a child in a child conveyance device, such as a stroller. Aspects and embodiments disclosed herein include an attachment mechanism configured to releasably secure a seat, such as a dual-purpose car seat, to a frame of the stroller. In one embodiment, the attachment mechanism is particularly suited to prevent rotation of the seat with respect to the frame of the stroller. Aspects of the attachment mechanism prevent rotational play (forward and backward play) due to part tolerances and typical operational clearances provided for most attachment designs. The attachment mechanism provides a central single coupling to secure the seat to the frame. The attachment mechanism further provides the ability to drop the seat on the frame of the stroller with one-handed operation both to secure and release the seat from the frame.

In some embodiments, the attachment mechanism includes an attachment mount, sometimes referred to as a saddle, mounted on the frame of the stroller and a mating attachment mount, sometimes referred to as a receiver mount provided under the seat. The mating attachment mount is configured to be releasably secured to the attachment mount when securing the seat to the frame of the stroller. The attachment mount and the mating attachment mount each include complementary V-shaped components in cross-directions that act as lead-ins or a guide for easy alignment when securing the seat to the frame during attachment. Once secured, the attachment mount and the mating attachment mount include a locking assembly configured to lock the attachment mount and the mating attachment mount together without any play between these components.

The disclosure is not limited in its application to the details of construction and the arrangement of components set forth in the following description or illustrated in the drawings. The disclosure is capable of other examples and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional terms.

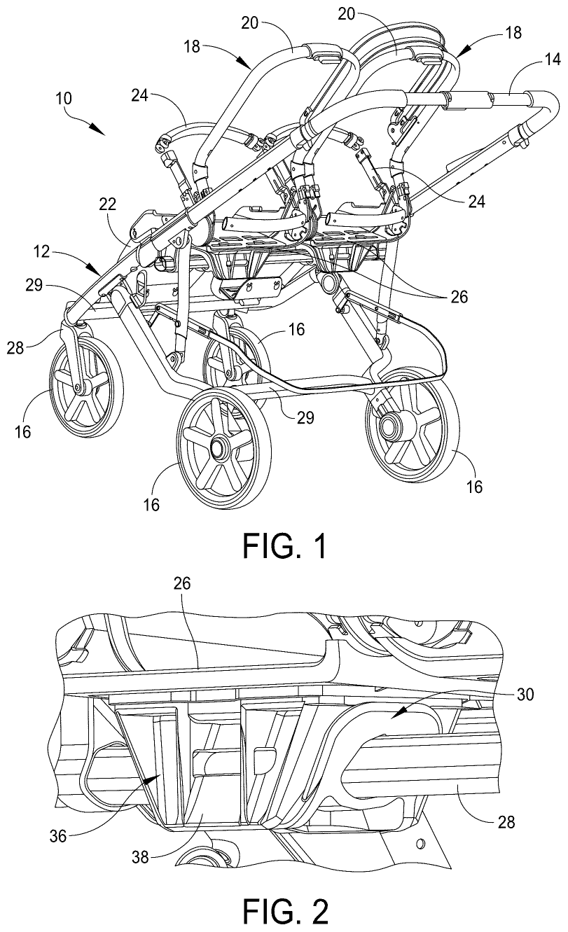

Referring to the drawings, and more particularly to FIG. 1, a stroller, generally indicated at 10, is shown in an open or operating condition. As shown, the stroller 10 includes a frame assembly, generally indicated at 12, which provides the support structure of the stroller 10. The frame assembly 12 includes a handlebar 14, which is used by the operator of the stroller 10 to push the stroller 10, and wheels, each indicated at 16, provided at the bottom corners of the frame assembly 12 of the stroller 10. As shown, the frame assembly 12 includes four wheels 16, however, the stroller can be configured with three wheels, one on the front of the stroller and two on the back of the stroller. In one embodiment, the frame assembly 12 of the stroller 10 includes several frame members that are coupled together and configured to collapse the stroller 10 to a collapsed position from its shown open or operable position.

The frame assembly 12 of the stroller 10 further is configured to support two seat frames, each generally indicated at 18, which as will be described in greater detail below are configured to be releasably secured to the frame assembly 12. Each seat frame 18 includes an upper frame portion 20, a lower frame portion 22, and a bumper bar portion 24. The upper frame portion 20, the lower frame portion 22, and the bumper bar portion 24 are configured to pivot about a cross member 26, which extends from one side of the seat frame 18 to the other side of the seat frame 18. In some embodiments, the cross member 26 may be referred to as a seat pan.

Referring additionally to FIG. 2, the frame assembly 12 of the stroller 10 further includes a crossbar 28 that extends from one side of the stroller 10 to an opposite side of the stroller 10. As will be described in greater detail below, the crossbar 28 is configured to support an attachment mechanism of an embodiment of the present disclosure. The crossbar 28 is positioned on the frame assembly 12 under the seat frame 18 when securing the seat frame 18 to the crossbar 28, with the attachment mechanism including two complimentary components that are V-shaped in cross directions to provide a guide to lead in and align the components. The attachment mechanism is configured to enable the two complementary components to be secured to one another with limited play or relative movement between the components. The frame assembly 12 of the stroller 10 further includes additional crossbars, each indicated at 29 provide strength and rigidity to the frame assembly 12. The attachment mechanism may be employed on these crossbars 29 instead of crossbar 28 as described herein.

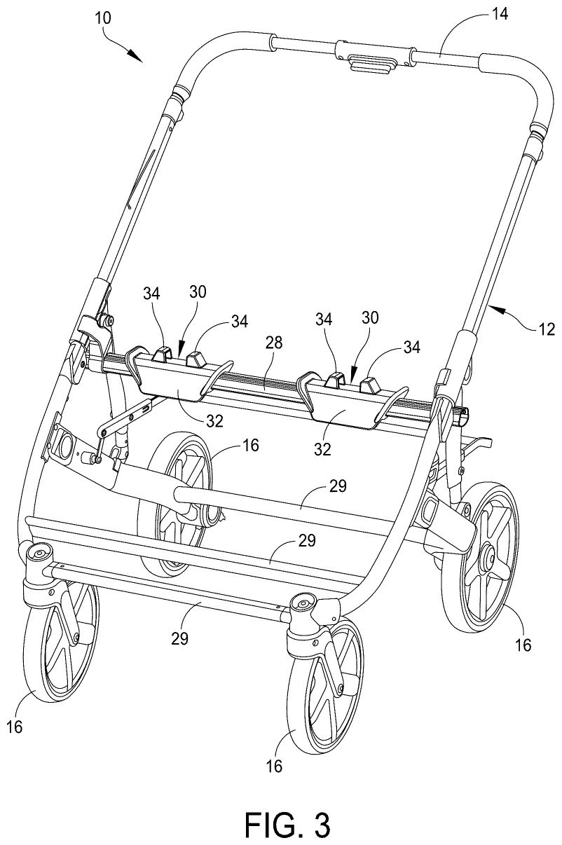

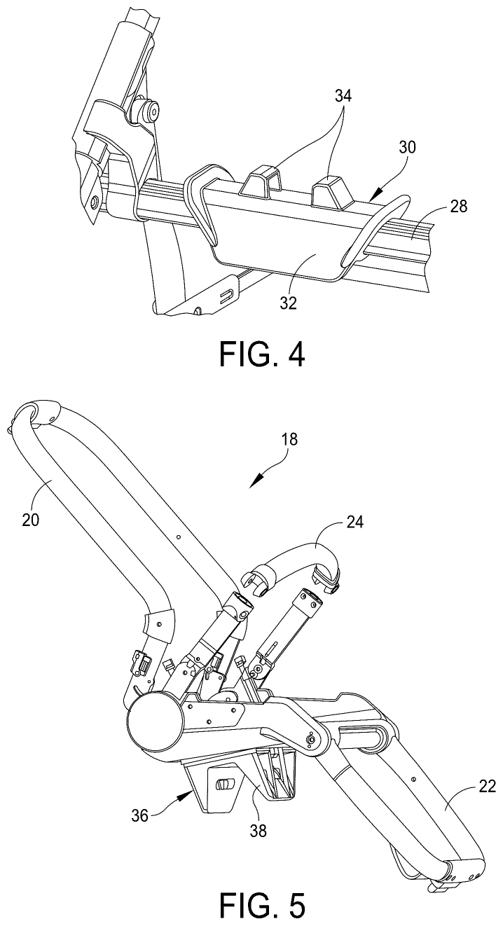

Referring additionally to FIGS. 3 and 4, the attachment mechanism includes two attachment mounts, each generally indicated at 30, which, in one embodiment, are each secured to the crossbar 28 of the frame assembly 12. In another embodiment, the attachment mounts 30 may be integrally formed with the crossbar 28 of the frame assembly 12. As used herein, the attachment mount 30 may sometimes be referred to as a saddle or saddle mount. The attachment mount 30 includes a hollow body, that is sized and shaped to fit over or around the crossbar 28, and two attachment features, each indicated at 34, which are provided to engage a complimentary attachment mount of the attachment mechanism. The attachment features 34 are formed on the hollow body 32 of the attachment mount 30 on the top of the hollow body 32 when the attachment mount 30 is secured to the crossbar 28. Each attachment mount 30 is configured to receive a seat frame 18 to secure the seat frame to the crossbar 28 of the frame assembly 12. Thus, for the stroller 10 shown in FIG. 3, the stroller 10 is configured to receive two seat frames 18 to enable the stroller 10 to support two children.

In some embodiments in which the stroller 10 is configured to secure two seat frames 18 to the frame assembly 12 of the stroller 10, the attachment mount can be configured with a single hollow body that is secured to the crossbar 28 and two separate attachment mount structures that each function as attachment mount 30. With this embodiment, each attachment mount structure is configured to receive a seat frame 18.

Referring to FIG. 5, the seat frame 18 is shown without the padding and some other components that constitute a fully assembled seat. As shown, the seat frame 18 further includes a mating attachment mount, generally indicated at 36, which is sometimes referred to simply as an attachment mount. In one embodiment, the mating attachment mount 36 is mounted on the underside of the seat pan 26 of the seat frame 18. In another embodiment, the mating attachment mount 36 is integrally formed with the seat pan 26 of the seat frame 18. As will be described in greater detail below, the mating attachment mount 36 is configured to be releasably secured to the attachment mount 30 on the crossbar 28 of the frame assembly 12 of the stroller 10 to secure the seat frame 18 to the frame assembly 12. The mating attachment mount 36 includes an inverted V-shaped body 38, which is configured to fit onto the hollow body 32 of the attachment mount 30. The mating attachment mount 36 is located at a midpoint of the cross member 26 of the seat frame 18 where connecting portions of the upper frame portion 20, the lower frame portion 22, and the bumper bar portion 24 meet. The inverted V-shaped body 38 faces in a downward direction toward the attachment mount 30 when securing the seat frame 18 to the frame assembly 12.

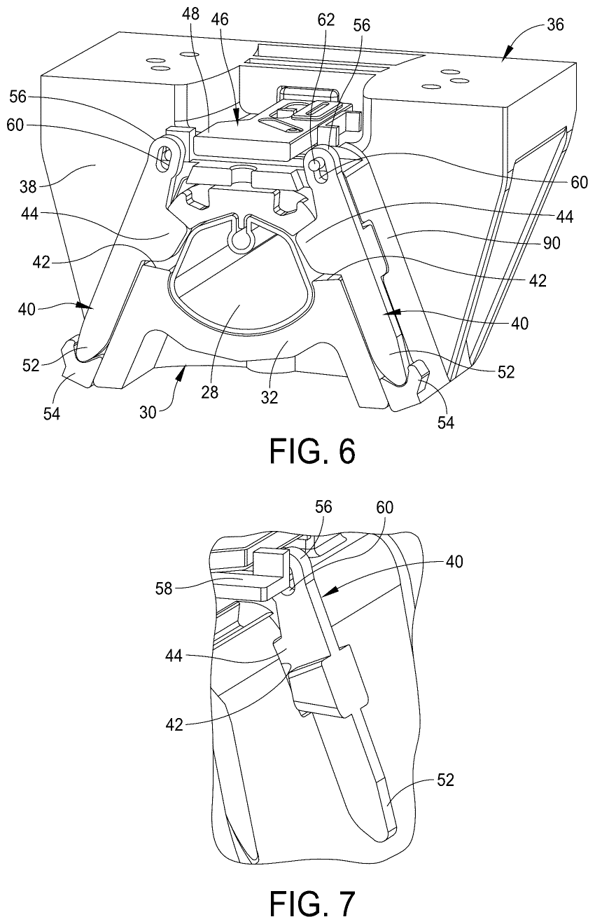

Referring to FIG. 6, the mating attachment mount 36 is secured to attachment mount 30. As shown, the inverted V-shaped body 38 of the mating attachment mount 36 is positioned over the hollow body 32 of the attachment mount 30. The hollow body 32 of the attachment mount 30 includes a V-shaped outer surface that receives the inverted V-shaped body 38 of the mating attachment mount 36. The mating attachment mount 36 further includes two spring-loaded latches, each generally indicated at 40, configured to be received in recesses, each indicated at 42, formed in the hollow body 32 of the attachment mount 30. Specifically, each spring-loaded latch 40 includes a wedge-shaped element 44 that is sized and shaped to fit within its respective recess 42 such that a top of the wedge-shaped element 44 of the spring-loaded latch 40 engages the top of the recess 42 and a bottom of the wedge-shaped element 44 engages the bottom of a corresponding recess 90 in the mating attachment mount 36 thereby creating a wedging action that tends to drive the mating parts together while eliminating any play between the parts. There is a small gap between adjacent horizontal surfaces of the hollow body 32 of the attachment mount 30 and the inverted V-shaped body 38 of the mating attachment mount 36 to ensure that contact is made on the sides of the V-shaped structures. FIG. 7 illustrates the spring-loaded latch 40 of the mating attachment mount 36, with the wedge-shaped element 44 of the spring-loaded latch 40 disposed within the recess 42 of the attachment mount and the recess 90 (not indicated) of the mating attachment mount 36.

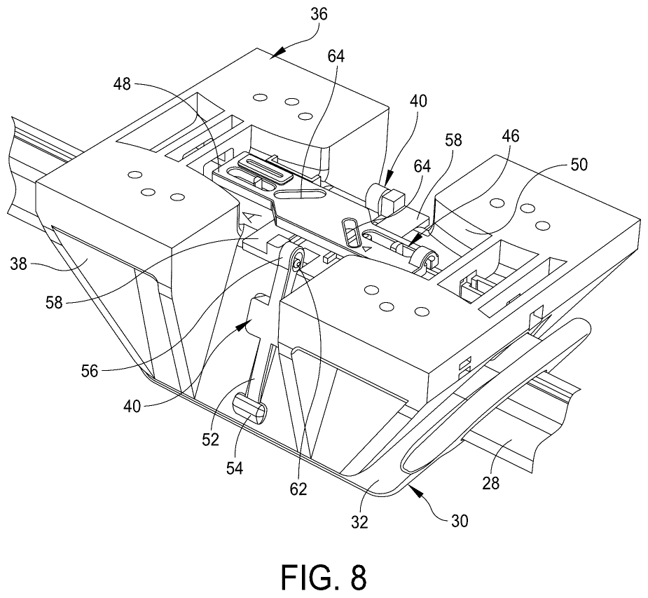

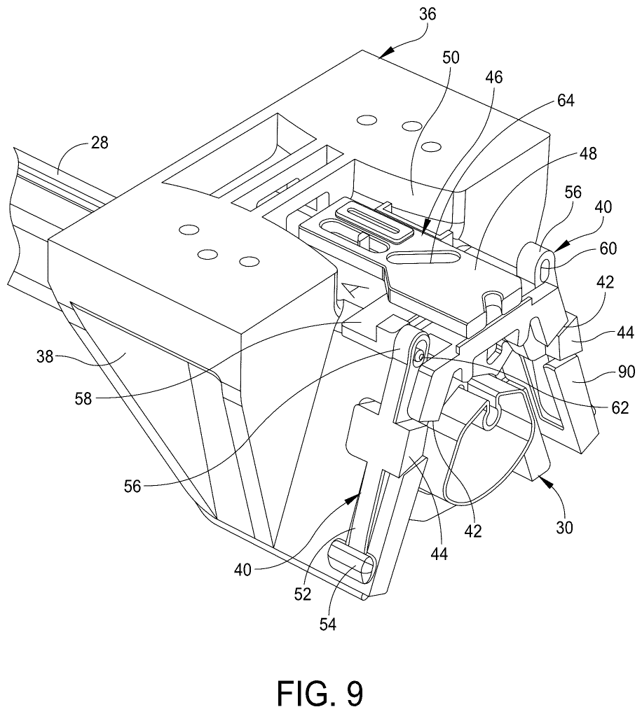

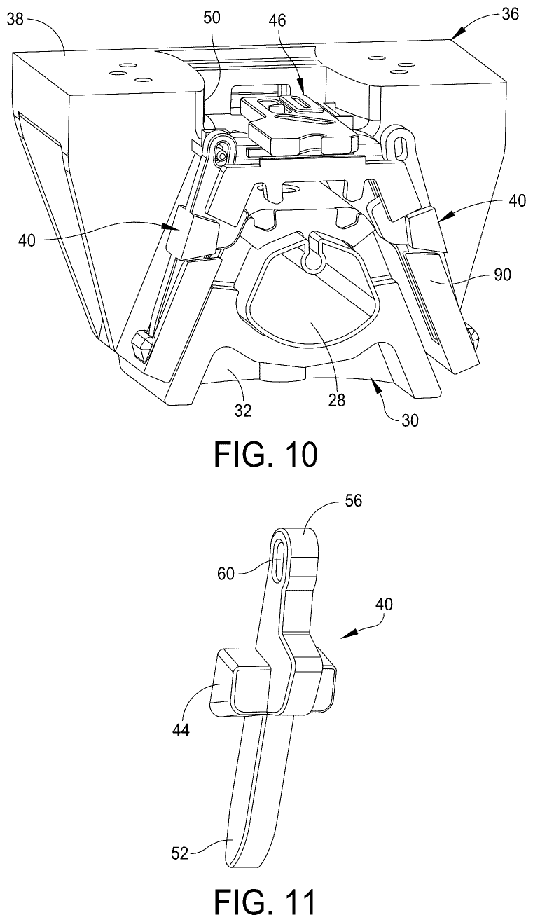

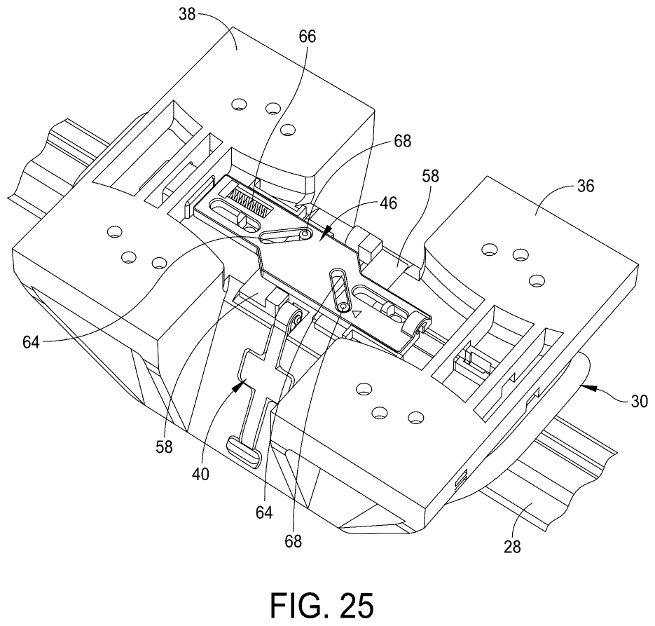

Referring to FIGS. 8-10, the mating attachment mount 36 further includes a release slide, generally indicated at 46, which is configured to control the release and securement of the mating attachment mount 36 to the attachment mount 30. As shown, the release slide 46 includes an elongated body 48, which is positioned within a slot 50 formed in a top surface of the inverted V-shaped body 38 of the mating attachment mount 36. The release slide 46 is configured to be biased to the left as shown in FIGS. 8 and 9 by a spring (not shown but shown below with reference to FIGS. 25-27). The release slide 46 in the biased condition is configured to secure the wedge-shaped elements 44 of the spring-loaded latches 40 within their respective recesses 42 and 90 to secure the mating attachment mount 36 to the attachment mount 30.

Each spring-loaded latch 40 includes a bottom end 52 that is captured within a retention feature 54 formed in the side of the inverted V-shaped body 38. Each spring-loaded latch 40 further includes a top end 56 that is coupled to a latch drive link 58. In one embodiment, the top end 56 of the spring-loaded latch 40 includes a small opening 60 (FIG. 11) that receives a pin 62 associated with the latch drive link 58. The latch drive link 58 is coupled to the release slide 46 so that when the release slide 46 is moved laterally against the bias of the spring, the latch drive link 58 is moved outboard with respect to the inverted V-shaped body 38 to rotate the spring-loaded latch 40 so that the wedge-shaped element 44 of the spring-loaded latch 40 is removed from its respective recesses 42, 90. The release slide 46 further includes two angled slots, each indicated at 64, and the latch drive link 58 includes another pin (not indicated) that is received within the angled slot 64. The arrangement is such that the angled slots 64 of the release slide 46 function as cams and the pins of the latch drive link 58 function as cam followers. This structure releases the spring-loaded latches 40 simultaneously when moving the release slide 46 to the release position, e.g., to the right as shown in FIG. 8.

Referring to FIG. 11, the spring-loaded latch 40 includes the bottom end 52, the top end 56, and the wedge-shaped element 44. As shown, the small opening 60 is formed in the top end 56 of the spring-loaded latch 40.

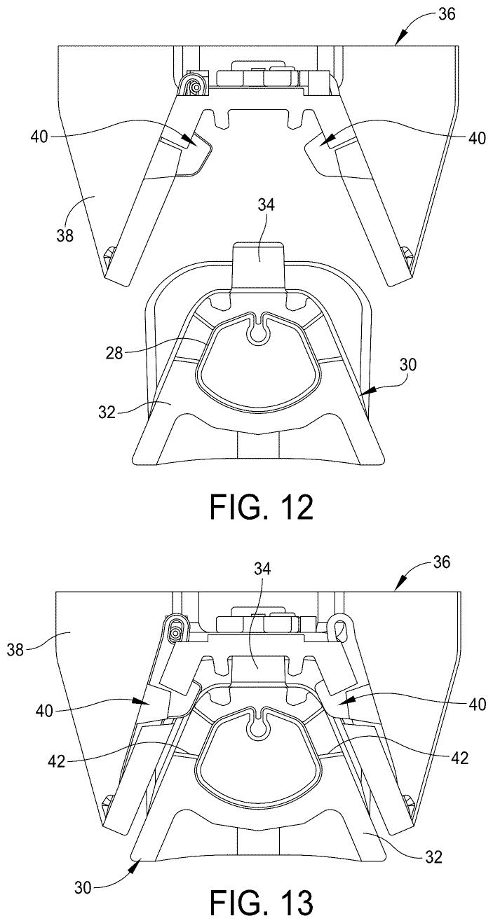

Referring to FIGS. 12-14, the sequence of attachment of the mating attachment mount 36 to the attachment mount 30 is illustrated. FIG. 12 shows the mating attachment mount 36 prior to being secured to the attachment mount 30. The attachment mount 30 is secured to the crossbar 28 of the frame assembly 12 of the stroller 10. The mating attachment mount 36 is positioned over a saddle post or posts, e.g., attachment feature 34, of the attachment mount 30 and lowered toward the saddle post. Large tapered “bounding” surfaces of the inverted V-shaped body 38 of the mating attachment mount 36 function as lead-ins to facilitate the proper alignment of the mating attachment mount 36 with respect to the attachment mount 30. In this position, the spring-loaded latches 40 are biased inwardly.

FIG. 13 shows the mating attachment mount 36 being lowered onto the attachment mount 30. The saddle post, e.g., attachment feature 34, is initially received within a saddle post recess formed in the bottom surface of the inverted V-shaped body 38 of the mating attachment mount 36. In this position, front surfaces of the spring-loaded latches 40 contact side surfaces of the hollow body 32 of the attachment mount 30 to force the spring-loaded latches 40 to move outwardly against the inward bias.

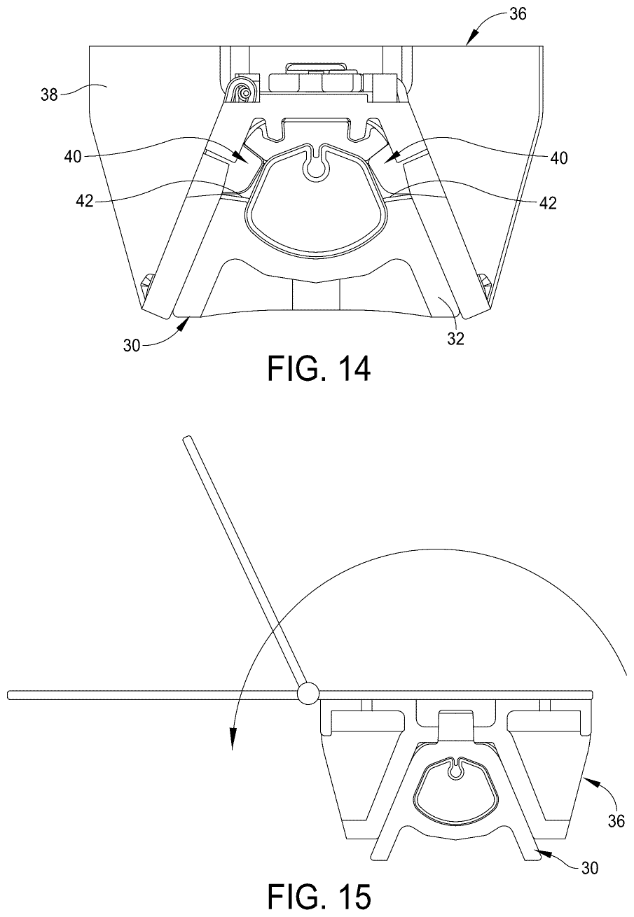

FIG. 14 shows the mating attachment mount 36 fully secured to the attachment mount 30. In this position, the surfaces of the mating attachment mount 36 contact surfaces of the attachment mount 30 and the spring-loaded latches 40 are biased into their respective recesses 42, 90, thereby wedging the two components together.

Referring to FIG. 15, a force diagram of the attachment mechanism is shown. The typical maximum forces encountered on the attachment mechanism vary for different accessories and applications. In one embodiment, a maximum static seat moment is 812.5 lbs.-in. (65 lbs. X 12.5 in.). The moment due to seat loading is handled by securing the mating attachment mount 36 to the attachment mount 30 and having a sufficient length from post to wall contact to create leverage sufficient to safely counter the forces. This arrangement allows these large forces to be handled by bigger features and to separate them from the anti-rotation locking components that may not be strong enough to withstand these forces alone.

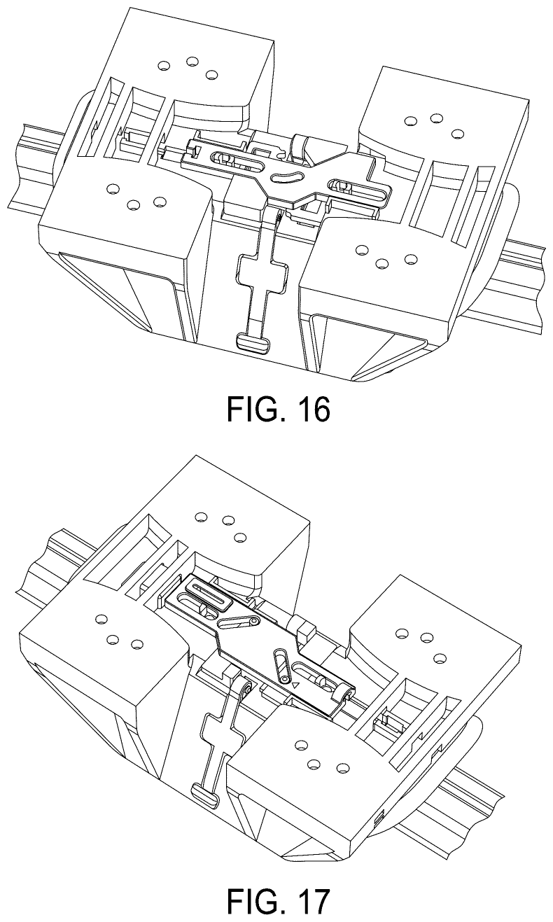

Referring to FIG. 16, a mating attachment mount of another embodiment of the disclosure is shown to include another releasing coupling. As shown, a pull or push slide via a cable, tab or other means is provided to transversely ramp out release drive links that push the latches out of their respective recesses.

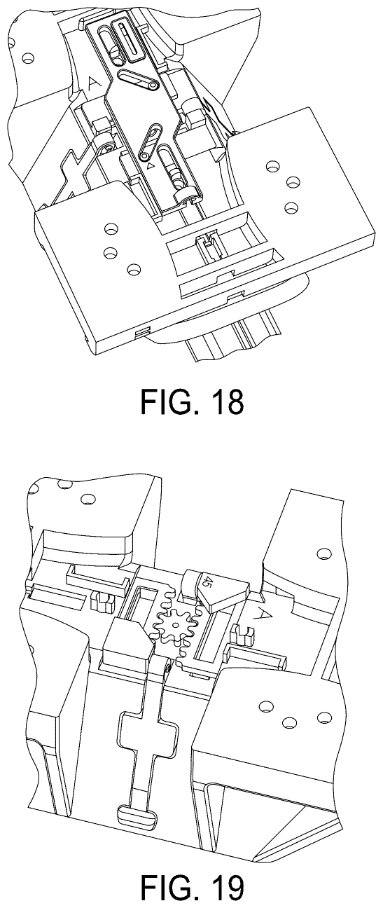

Referring to FIGS. 17 and 18, a mating attachment mount of another embodiment of the disclosure is shown to include another releasing coupling. Ramped slots in slide drive posts on a drive link push out the latches. Opposing slots ensure that latches move equally and opposite one another.

Referring to FIG. 19, a mating attachment mount of another embodiment of the present disclosure is shown to include another releasing coupling. A gear is provided to drive the opposite motion of the latches.

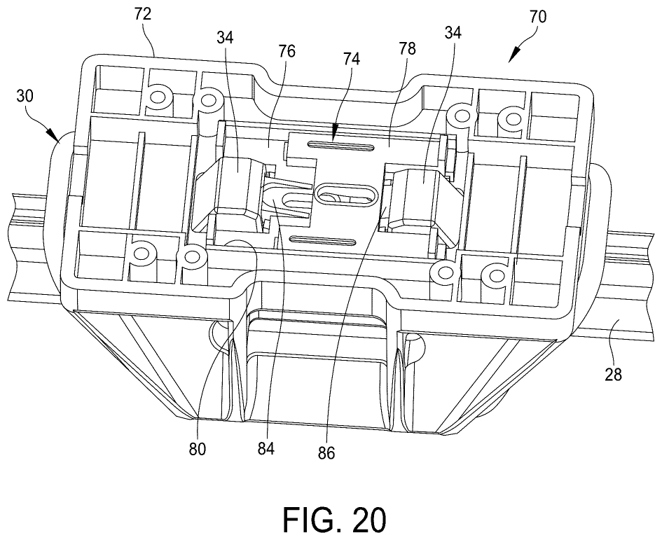

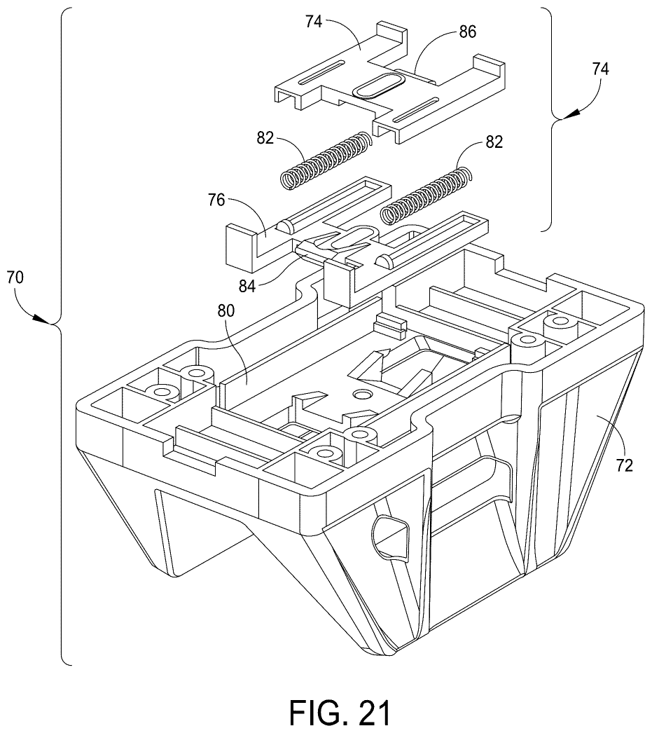

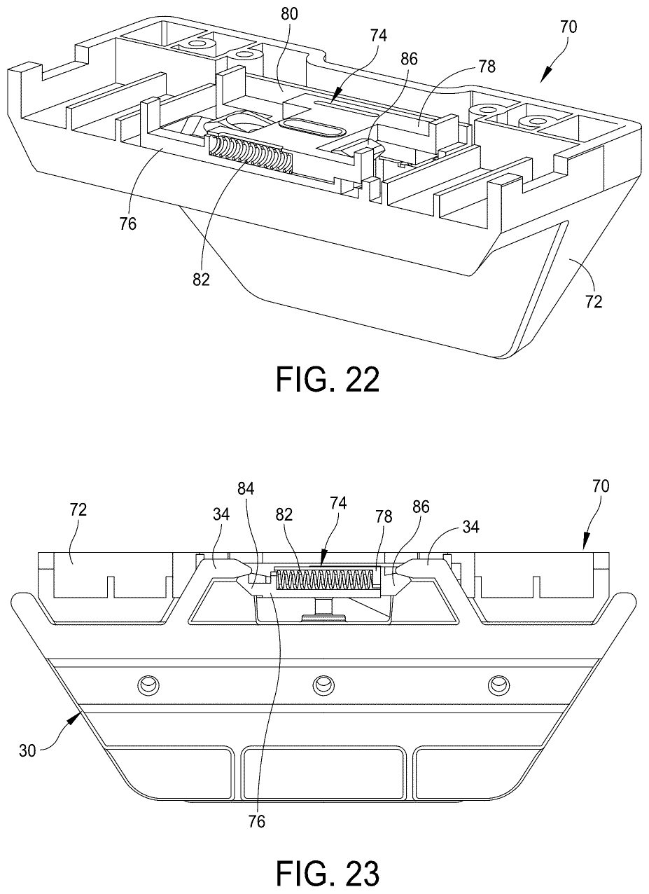

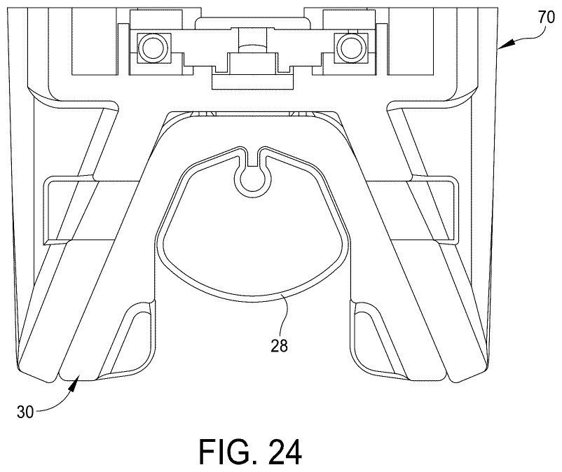

Referring to FIGS. 20-23, a mating attachment mount of another embodiment of the present disclosure, generally indicated at 70, is shown to include another securing and releasing coupling. As with mating attachment mount 36, mating attachment mount 70 is mounted on the underside of the cross member 26 of the seat frame 18. The mating attachment mount 70 is configured to be releasably secured to the attachment mount 30 on the crossbar 28 of the frame assembly 12 of the stroller 10 to secure the seat frame 18 to the frame assembly 12. The mating attachment mount 70 includes an inverted V-shaped body 72, which is configured to fit onto the hollow body 32 of the attachment mount 30. The inverted V-shaped body 72 faces in a downward direction toward the attachment mount 30 when securing the seat frame 18 to the frame assembly 12.

The mating attachment mount 70 further includes a release slide assembly, generally indicated at 74, which is configured to control the release and securement of the mating attachment mount 70 to the attachment mount 30. As shown, the release slide assembly 74 includes a first slide 76 and a second slide 78, which interact with one another to secure the mating attachment mount 70 to the attachment features 34 of the attachment mount 30. The first slide 76 and the second slide 78 of the release slide assembly 74 is positioned within a slot 80 formed in a top surface of the inverted V-shaped body 72 of the mating attachment mount 70.

The first slide 76 of the release slide assembly 74 includes two springs, each indicated at 82, to bias the second slide 78 away from the first slide 76. The first slide 76 includes a first tongue 84, which is configured to be received in one attachment feature 34. The second slide 78 includes a second tongue 86, which is configured to be received in the other attachment feature 34. The first and second tongues 84, 86 of the first and second slides 76, 78, respectively, operate horizontally by engaging recesses provided within respective attachment features 34 of the attachment mount 30. The springs 82 are provided to bias the two opposing slides 76, 78, and by pushing the slides 76, 78 toward one another disengages the tongues 84, 86 from their respective attachment features 34.

FIG. 24 illustrates the mating attachment mount 70 shown in FIG. 20, showing dimensions of the mating attachment mount 70 as mounted on attachment mount 30.

FIG. 25 illustrates the mating attachment mount shown in FIGS. 5-15, showing a spring 66 used to bias the release slide 46. Also, pins, each indicated at 68, of the latch drive links 58 are shown within their respective angled slots 64 of the elongated body 48 of the release slide 46.

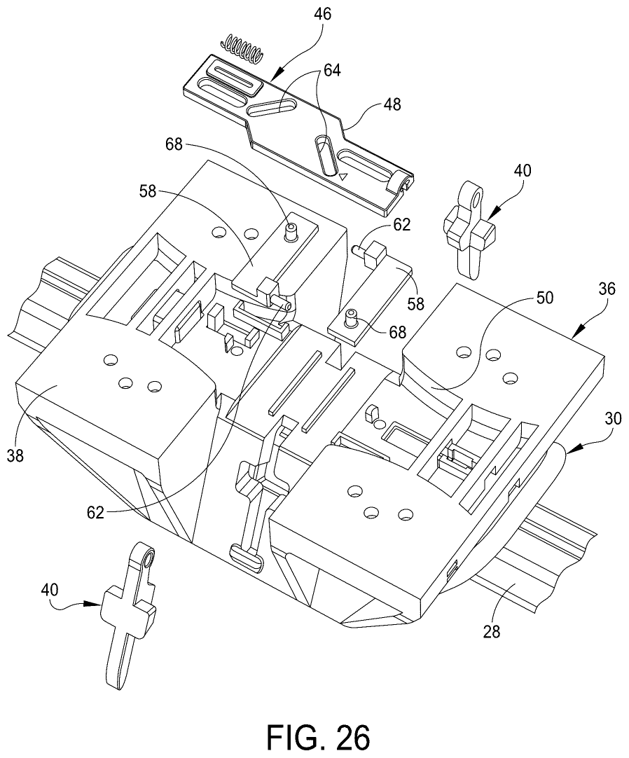

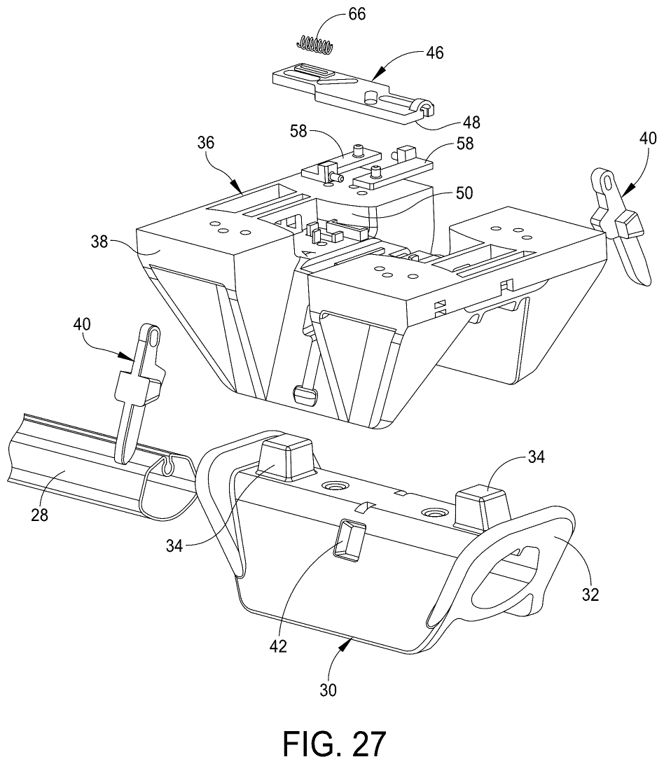

FIGS. 26 and 27 are enlarged exploded perspective view of the attachment mount 30 and the mating attachment mount 36 shown in FIGS. 5-15.

The materials of construction of the components of the frame assembly and the linkage may embody strong, lightweight materials, such as aluminum and aluminum alloys.

Having thus described several aspects of at least one embodiment of this disclosure, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A stroller comprising:
a frame;
a seat configured to be releasably secured to the frame;
an attachment mount associated with the frame;
a mating attachment mount associated with the seat, the mating attachment mount having a shape configured to conform to a shape of the attachment mount; and
a locking assembly configured to releasably secure the mating attachment mount to the attachment mount.

2. The stroller of claim 1, wherein the attachment mount includes a hollow body configured to fit over a crossbar of the frame.

3. The stroller of claim 2, wherein the attachment mount further includes at least one attachment feature formed on the hollow body on the top of the hollow body, the at least one attachment feature being configured to prevent relative rotation of the mating attachment mount with respect to the attachment mount.

4. The stroller of claim 2, wherein the hollow body includes a V-shaped outer surface.

5. The stroller of claim 4, wherein the mating attachment mount includes an inverted V-shaped body configured to fit over the V-shaped outer surface of the hollow body of the attachment mount.

6. The stroller of claim 5, wherein the locking assembly includes at least one latch configured to engage a recess formed in the hollow body of the attachment mount.

7. The stroller of claim 6, wherein the at least one latch includes a wedge-shaped element that is sized and shaped to fit within the recess of the hollow body of the attachment mount.

8. The stroller of claim 6, wherein the locking assembly further includes a release slide that is configured to secure the mating attachment mount to the attachment mount.

9. The stroller of claim 8, wherein the release slide is positioned within a slot formed in a top surface of the inverted V-shaped body of the mating attachment mount.

10. The stroller of claim 8, wherein the release slide is configured to be biased by a spring to move the wedge-shaped element of the at least one latch within the recesses of the attachment mount and the mating attachment mount to secure the mating attachment mount to the attachment mount.

11. The stroller of claim 10, wherein the at least one latch includes a bottom end portion that is captured within a retention feature formed in the side of the inverted V-shaped body.

12. The stroller of claim 11, wherein the at least one latch further includes a top end portion that is coupled to a latch drive link.

13. The stroller of claim 12, wherein the latch drive link is coupled to the release slide so that when the release slide is moved laterally against the bias of the spring, the latch drive link is moved outboard with respect to the inverted V-shaped body to rotate the latch so that the wedge-shaped element of the latch is removed from its respective recess.

14. The stroller of claim 3, wherein the mating attachment mount includes a release slide that is configured to releasably secure the mating attachment mount to the at least one attachment feature of the attachment mount.

15. The stroller of claim 14, wherein the release slide is positioned within a slot formed in a top surface of an inverted V-shaped body of the mating attachment mount.

16. The stroller of claim 14, wherein the release slide includes a first slide portion and a second slide portion that is configured to be biased away from the first slide portion.

17. The stroller of claim 16, wherein the second slide portion is biased away from the first slide portion by a spring.

18. A method of releasably securing a seat to a frame of a stroller, the method comprising:
providing an attachment mount with the frame of the stroller;
providing a mating attachment mount with the seat;
positioning the mating attachment mount of the seat over the attachment mount of the frame of the stroller;
lowering the mating attachment mount of the seat onto the attachment mount of the frame so that surfaces of the mating attachment mount guide the attachment mount over surfaces of the attachment mount; and
releasably securing the mating attachment mount of the seat to the attachment mount of the frame of the stroller,
wherein the mating attachment mount has a shape configured to conform to a shape of the attachment mount and a locking assembly configured to releasably secure the mating attachment mount to the attachment mount.

19. The method of claim 18, wherein attachment mount includes a hollow body configured to fit over a crossbar of the frame, the method further comprising preventing relative rotation of the mating attachment mount with respect to the attachment mount with at least one attachment feature formed on the hollow body on the top of the hollow body.

20. The method of claim 19, wherein the hollow body includes a V-shaped outer surface and the mating attachment mount includes an inverted V-shaped body configured to fit over the V-shaped outer surface of the hollow body of the attachment mount.

21. The method of claim 19, wherein releasably securing the mating attachment mount of the seat to the attachment mount includes moving a releasable slide of the mating attachment mount to engage the at least one attachment feature of the attachment mount.
